(19) United States
(12) Patent Application Publication
(10) Pub. No.: US 2016/0257544 A1
(43) Pub. Date: Sep. 8, 2016

(54) APPARATUS TO EXTRACT FOREIGN OBJECTS FROM A TIRE TREAD

(71) Applicant: SKIP A LEI, PORTLAND, OR (US)

(72) Inventor: SKIP A LEI, PORTLAND, OR (US)

(21) Appl. No.: 14/640,691

(22) Filed: Mar. 6, 2015

(51) Int. Cl. B66F 15/00

(52) U.S. Cl. CPC B66F 15/00

(57) ABSTRACT

An apparatus for removing a foreign object, such as a rock, from a tire tread consists of an elongated, shaft member with a hook member on one end and an integrated handle at the other end with means to attach the apparatus to a key chain. Inserting the hooked end of the apparatus into a tire tread and manually maneuvering the hook under the foreign object and pulling outward on the handle allows the hook portion of the apparatus to remove the foreign object from a tire tread.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention generally relates to a low cost, portable, device for extracting a rock or other such foreign object from a tire tread, and more particularly an object removal tool that is shaped like a key for ease of use and transportation.

Tire maintenance is important to the health of a tire. Regular and proper maintenance of a tire increases the safety of a driver, and all the passengers in a car. In addition to regularly checking the air pressure in a tire, it is important to check the amount of tire tread depth, and to remove foreign objects from the tire tread, such as rocks, glass, and other debris that gets picked up by the tire tread while driving.

Drivers who care about their tires will normally take a look at their tires when they are getting into or out of their car, especially in cars that feature “performance rated tires” which tend to be of slightly softer compound and, at times, offer greater siping. They may notice a rock or other foreign object in the tread and immediately want to remove the object while they are thinking about it. Often the only “tools” they have available are the keys to the car, or other keys on a key ring, such as a house key or a smaller mailbox key. The driver will then make a choice about which key to use to pry the rock or foreign object out of the tire tread. A drawback of using a working key is that there is a real chance that the key being used to pry out the rock will be damaged in the process and result in the need to get a new car key or house key. For this reason, functional keys should be avoided as a tire maintenance tool.

A second option is to use another alternative inappropriate ad-hoc tool such as a screw driver or a ball-point pen to pry out the foreign object from the tire tread. The use of a sharp object, such as a screw driver, can result in damage to the tire itself, or the breaking of the pen resulting in injury to the user. As such, use of sharp objects must be avoided when working on a tire tread.

The present invention was created to be a simple to use, low cost, easily transportable tool that will be with a driver every time they examine the tires, to remove foreign objects from a tire tread in order to promote better “tire hygiene”. In addition, the tool has the added capability to measure tire tread depth to determine if a new tire is needed.

### BRIEF SUMMARY OF THE INVENTION

The present invention is preferably a single part, or article of manufacture, that is made from strong, rigid material that will retain the integrity of its shape during use. This device is shaped as a normal size car key to fit on a key chain. It would have a handle portion, or shape at the top of the key to use as both a “holder” and a “twister,” and may be of any shape that is large enough to allow a thumb and index finger to grasp, turn and pull the device. Preferably, the present invention would be of a flat shaped elongated shaft having a hook at a lower, distal end for insertion into a tire tread with an angle of the hook of a sufficient degree to engage a foreign object in the tire tread, and having a handle at the upper, or proximal end to aid in working the hook under the foreign object in a tire tread. The hook would be used to engage the foreign object, such as a rock, and by pulling back on the device, thereby thoughtfully popping/freeing and removing the foreign object out of the tire tread.

In addition, and end of the device could have an indicator marked approximately 2/32 of an inch from the end to act as a tire tread depth indicator. In the preferred embodiment, the hook end of the key device would have an indicator marked approximately 2/32 of an inch from the end to act as a tire tread depth indicator. The National Highway Transportation Safety Administration (NHTSA) recommends on its website “Tires must be replaced when the tread is worn down to 2/32 of an inch in order to prevent skidding and hydroplaning. An easy test: place a penny into a tread grove. If part of Lincoln's head is covered by the tread, you're driving with the proper amount of tread. If you can see all of his head, you should buy a new tire.” http://www.nhtsa.gov/. This invention eliminates the need to carry change in your pocket to test the tire tread. While removing foreign objects from the tire tread, a user can also see if the 2/32 of an inch indicator on the hook end of the key is covered by the tread or not, and get a new tire if needed.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE SEVERAL VIEWS OF THE DRAWING

FIG. 1 is a plan view showing one embodiment of the device in accordance with this invention.

### DETAILED DESCRIPTION OF THE INVENTION

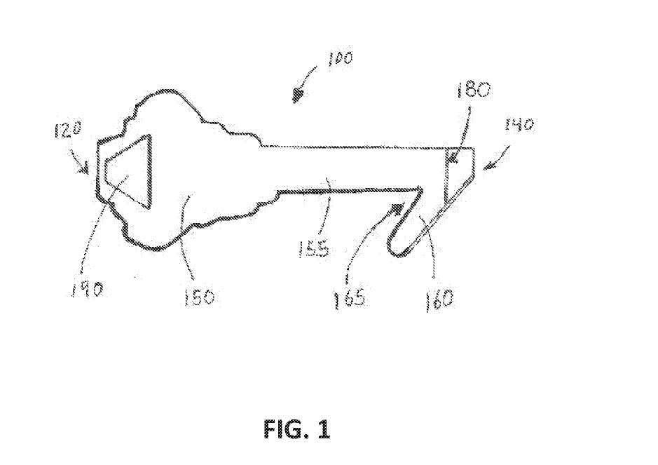

Referring now to FIG. 1, the apparatus of the present invention, the “Rock Key” as it is at times referenced herein, is generally shown in the Figure as reference numeral 100.

Apparatus 100 has a proximal end 120 and a distal end 140, and consists of a handle 150 with an extended or elongated shaft 155 formed into a hook 160 at distal end 140. In the preferred embodiment, as shown, distal end 140 is a flat surface, and approximately 2/32 of an inch from the distal end 140 toward the proximal end 120 is a tire depth indicator 180. In normal use, when distal end 140 is inserted into a tire grove, or tire tread, if tire depth indicator cannot be seen, then the tread is safe. However, if tire depth indicator is visible above the tire tread when the distal end 140 is inserted into a tire grove then a user is given a visual indicator that the tire (not shown) is in need of being replaced.

Turning now to hook 160, in the preferred embodiment, the hook has an angle 165 that is sufficiently wide to allow hook 160 to engage a foreign object (not shown) in a tire tread (not shown) between the shaft 155 and the hook 160 so that when a user pulls on handle 140 the foreign object caught in a tire tread is forced by the pulling force to be captured between the shaft 155 and the hook 160 and extracted from a tire tread. In the preferred embodiment, angle 160 is less than 90 degrees, and more than 30 degrees.

Turning now to handle 150, there is an attachment means 190 formed in the handle 150 to provide a means to attach the apparatus 100 to a key chain (not shown). This attachment means 190 is preferably an opening 190 formed through handle 150, the opening being of any shape or size sufficient to attach the Rock Key to a key chain. Attachment means 190, however could be a clip (not shown) or clasp (not shown) rather than an opening to provide an alternative means of attaching the apparatus 100 to a key chain.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed as new and desired to be protected by Letters Patent is set forth in the appended claims.

What is claimed is:

1. Apparatus for removing a foreign object from a tire tread, comprising:
(a) an elongated shaft;
(b) the elongated shaft having a portion substantially formed as a hook at one end; and
(c) a handle, wherein the handle is integrated to the shaft at the end of the shaft opposite the hook end of the shaft.

2. The apparatus of claim 1, wherein the hook has an angle formed between the elongated shaft and the hook that is less than 90 degrees.

3. The apparatus of claim 1, further having a tire depth indicator formed on an end of the apparatus.

4. The apparatus of claim 3, wherein the tire depth indicator is formed on the hook end of the apparatus.

5. The apparatus of claim 1, wherein the handle has a means to attach the apparatus to a key chain.

6. The apparatus of claim 5, wherein the means to attach the apparatus to a key chain is an opening formed through the handle.

7. Apparatus, in the shape and size of a standard key, for removing a foreign object from a tire tread, comprising:
(a) an elongated shaft;
(b) the elongated shaft having a portion substantially formed as a hook at one end;
(c) a tire depth indicator formed in the hook end of the apparatus; and
(d) a handle, wherein the handle is integrated to the shaft at the end of the shaft opposite the hook end of the shaft.
